(19) United States
(12) Patent Application Publication
(10) Pub. No.: US 2023/0246698 A1
(43) Pub. Date: Aug. 3, 2023

(54) CONFIGURING A USER EQUIPMENT

(71) Applicant: Telefonaktiebolaget LM Ericsson (publ), Stockholm (SE)

(72) Inventors: Saeed BASTANI, Lund (SE); Ashkan KALANTARI, Malmö (SE); Bhavinkumar PATEL, Malmö (SE); Mohammed ZOUROB, Bunkeflostrand (SE)

(21) Appl. No.: 18/002,584

(22) PCT Filed: Jun. 26, 2020
(86) PCT No.: PCT/EP2020/068158

§ 371 Date: Dec. 20, 2022

(51) Int. Cl. H04B 7/06; H04B 7/0404; H04W 64/00

(52) U.S. Cl. CPC H04B 7/0695; H04B 7/0404; H04W 64/00

(57) ABSTRACT

Methods and apparatus are provided. In an example aspect, method of configuring a User Equipment (UE) is provided. The method includes detecting a movement of the UE, determining a context of the UE in response to the detected movement, and configuring at least one parameter of wireless communication between the UE and a base station based on the context of the UE and the detected movement.

### TECHNICAL FIELD

Examples of the present disclosure relate to configuring a User Equipment, UE, for example configuring a wireless communication link between the UE and a base station.

### BACKGROUND

The general approach for configuring communication parameters for wireless communication between a User Equipment (UE) such as a mobile phone and a base station is similar regardless of the particular use case of the UE. For example, the current cellular system uses traditional beam training algorithms such as exhaustive and repeated search in order to find the best transmit and receive beams for wireless communication between the UE and the base station, and this is the same for all UEs communicating with the base station.

### SUMMARY

One aspect of the present disclosure provides a method of configuring a User Equipment (UE). The method comprises detecting a movement of the UE, determining a context of the UE in response to the detected movement, and configuring a wireless communication link between the UE and a base station based on the context of the UE and the detected movement.

A further aspect of the present disclosure provides apparatus for configuring a User Equipment (UE). The apparatus comprises a processor and a memory. The memory contains instructions executable by the processor such that the apparatus is operable to detect a movement of the UE, determine a context of the UE in response to the detected movement, and configure a wireless communication link between the UE and a base station based on the context of the UE and the detected movement.

An additional aspect of the present disclosure provides apparatus for configuring a User Equipment (UE). The apparatus is configured to detect a movement of the UE, determine a context of the UE in response to the detected movement, and configure a wireless communication link between the UE and a base station based on the context of the UE and the detected movement.

### BRIEF DESCRIPTION OF THE DRAWINGS

For a better understanding of examples of the present disclosure, and to show more clearly how the examples may be carried into effect, reference will now be made, by way of example only, to the following drawings in which:

FIG. 1 is a flow chart of an example of a method of configuring a User Equipment (UE);

FIG. 2 is a flow chart of another example of a method of configuring a User Equipment (UE); and

FIGS. 3(a) and 3(b) show examples of selection of a subset of available beams for measurement or use according to some examples; and

FIG. 4 is a schematic of an example of apparatus for configuring a UE.

### DETAILED DESCRIPTION

The following sets forth specific details, such as particular embodiments or examples for purposes of explanation and not limitation. It will be appreciated by one skilled in the art that other examples may be employed apart from these specific details. In some instances, detailed descriptions of well-known methods, nodes, interfaces, circuits, and devices are omitted so as not obscure the description with unnecessary detail. Those skilled in the art will appreciate that the functions described may be implemented in one or more nodes using hardware circuitry (e.g., analog and/or discrete logic gates interconnected to perform a specialized function, ASICs, PLAs, etc.) and/or using software programs and data in conjunction with one or more digital microprocessors or general purpose computers. Nodes that communicate using the air interface also have suitable radio communications circuitry. Moreover, where appropriate the technology can additionally be considered to be embodied entirely within any form of computer-readable memory, such as solid-state memory, magnetic disk, or optical disk containing an appropriate set of computer instructions that would cause a processor to carry out the techniques described herein.

Hardware implementation may include or encompass, without limitation, digital signal processor (DSP) hardware, a reduced instruction set processor, hardware (e.g., digital or analogue) circuitry including but not limited to application specific integrated circuit(s) (ASIC) and/or field programmable gate array(s) (FPGA(s)), and (where appropriate) state machines capable of performing such functions.

As indicated above, at present, configuration of communication parameters for wireless communication between a UE and a base station is similar regardless of the particular use case of the UE. However, understanding the motion types of a UE can enable many improvements for wireless communication. For example, movement of the UE (e.g. change in geographic location and/or orientation of the UE) can affect the cellular parameters of the UE, such as for example the best beam to use for wireless communication and/or the best antenna to use.

If UE movement (defined herein as a change in location and/or orientation) are considered, in some cases, smarter and faster decisions can be made for configuration of communication parameters (e.g. which beam(s) and/or antenna(s) to use), which may lead to improvements, such as for example better power consumption and/or more efficient utilization of resources. For example, exhaustive beam search as used presently may consume battery resources and increase latency (e.g. before wireless transmission of data begins). Also, periodic and exhaustive beam training approaches may lead to consumption of battery, increased latency and/or interruptions in wireless communication. In addition, using resources for exhaustive searches and their associated measurements may reduce average cell throughput for the base station.

Examples of this disclosure may therefore use detected movement (e.g. a change in location and/or orientation) of a UE, together with a context of the UE, to configure a wireless communication link between the UE and a base station. This may lead to for example a reduction in the number and extent of the number of beams that are searched to select beam(s) for wireless communication, and/or selection of one or more antennas that are for example considered or predicted to be optimal for the wireless communication based on the movement and context. In some examples, the movement and context may be used to predict a position and/or orientation of the UE during the wireless communication.

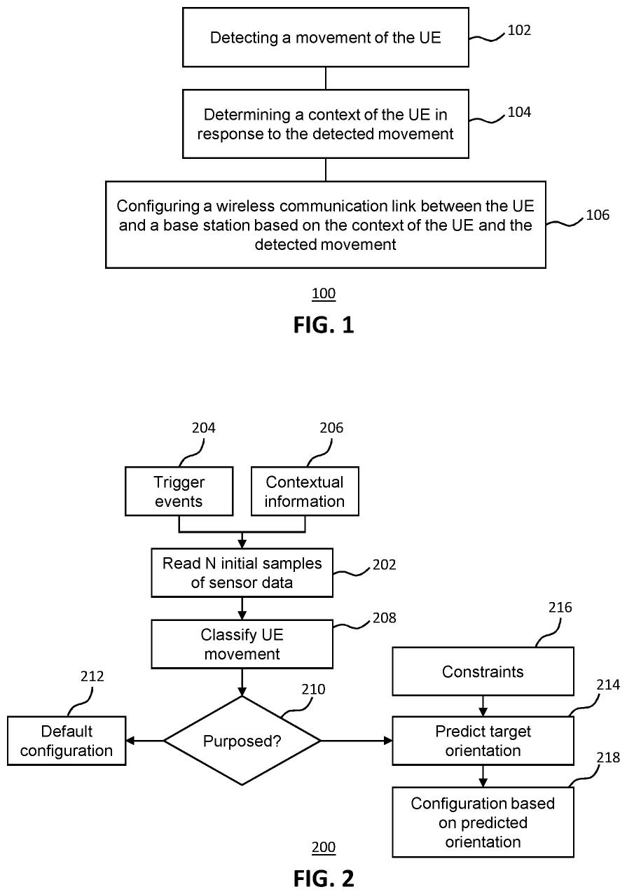

FIG. 1 is a flow chart of an example of a method 100 of configuring a User Equipment (UE). The method comprises, in step 102, detecting a movement of the UE. This may be done for example based on sensor data from at least one of a motion sensor, accelerometer, inertial motion unit, gyroscope, compass and camera. In some examples, the movement may be purposed, e.g. the user intends to use or interact with the UE to make a voice or video call, view an email or notification, send a communication (e.g. email, notification etc) or any other use or interaction.

Step 104 of the method 100 comprises determining a context of the UE in response to the detected movement. This may be for example any information that can be used to determine whether the user will use or interact with the UE or use the UE for the wireless communication, and/or can be used to predict the position and/or orientation of the UE during the wireless communication. In particular examples, the context of the UE may comprise a current time, a device type of the UE, and/or whether the UE is receiving or has received an incoming call, notification, text message, email and/or other communication, and/or whether a user of the UE has any calls, meetings, appointments and/or communications scheduled for a current time.

The method 100 also comprises, in step 106, configuring a wireless communication link between the UE and a base station based on the context of the UE and the detected movement. Thus for example the wireless communication may be optimized based on the detected movement and the context of the UE.

In particular examples, output of one or more Inertial Motion Unit (IMU) sensors (e.g. acceleration, gyroscope and/or magnetometer) along with contextual information of the UE may be used to make two predictions. Firstly, a prediction or deduction is made as to whether the detected motion of the UE that was detected in step 102 of the UE is purposed or non-purposed. In some examples, purposed movements may be defined as those movements that are the result of the user of the UE acting deliberately to move the UE from a given starting point (e.g. in the user's pocket) to a predicted target point suitable for interacting with the UE, such as for example executing/using a service on the UE (e.g. answering a call), or deliberately moving the UE without the intention of using interacting with it, e.g. the user pulling the UE out of their pocket and putting it on a table. Therefore, purposed UE movement may in some examples involve an intentional act by the user, otherwise it is regarded as non-purposed motion.

Secondly, if the movement is predicted to be purposed, a second prediction is made regarding the position and/or orientation of the UE at a future point in time. For example, from the current time “t” (also referred to herein as the initial state), the position and/or orientation of the UE at time “t+n” (referred to herein as a target or dwelling state) may be predicted, where “t+n” is a time when for example the UE remains in a user-intended relatively static position and/or orientation. The predicted position/orientation can be used for different purposes. For example, they can be mapped to a set of beams for more efficient beam training (i.e., measurement and reporting by the UE). Thus for example a reduced set of beams may be searched instead of an exhaustive search. Alternatively, if the UE motion is predicted to be non-purposed, the UE may instead use a default wireless communication configuration, e.g. a default beam training mode such as exhaustive or hierarchical search.

Some examples make use of available sensor data in the UE including IMU information to configure the communication settings. However, using such information (e.g. reading, collecting and processing of such information) may incur some cost at the UE in terms or processing time and battery consumption. Therefore, by making distinction between purposed and non-purposed UE movements, the UE may in some examples discard IMU sensor data reading and processing when the UE movement is predicted to be non-purposed. Also, even if the UE movement was predicted as a purposed movement, the UE may in some examples use only a few sensor readings to predict the subsequent UE orientation/position. This may lead to power saving in the UE due to the small number of IMU readings and computations.

In another particular example, suppose that the UE is in the user's pocket (initial state) and is picked up or lifted by the user (detected movement) as the UE receives a call (contextual information). From this initial state and, in some examples, additional data from the IMU after the UE has been picked up or lifted by the user, the UE predicts the target orientation, which in this example may be being held on or next to the user's ear, or held in front of the user if the user uses a speakerphone or hands-free equipment. This may in some examples further allow the UE to predict the full trajectory of the UE during the movement to the target orientation from the initial state to the target state. This information may be further used to filter irrelevant beams, and only focus on training the beams that will be incident to the predicted trajectory. That is, for example, any beam search that is performed as a result of movement of the UE or the incoming call may be restricted to a subset of available beams, where the subset include one or more beams that are considered to be advantageous or optimal over the other beams in the target orientation. In some examples, the target position/orientation is predicted only for those movements that are predicted to be purposed (based on the context of the UE).

Referring back to FIG. 1, step 106 of configuring a wireless communication link between the UE and a base station based on the context of the UE and the detected movement may in some examples comprise predicting an orientation or range of orientations of the UE based on the context of the UE and/or the detected movement, and configuring the wireless communication link between the UE and a base station based on the predicted orientation or range of orientations of the UE. In some examples, the orientation or range of orientations of the UE may be predicted based additionally on additional movement of the UE after the detecting in step 102 (or the determining in step 104). This may be done for example using a pattern matching, linear regression or machine learning algorithm. In some examples, the method 100 may comprise predicting the orientation or range of orientations of the UE based on the detected movement (i.e. the movement before the detecting in step 102, e.g. using data from the IMU that was used to detect the movement or before the determining in step 104) using a pattern matching, linear regression or machine learning algorithm.

The method 100 may in some examples comprise reporting the orientation or range of orientations to the base station to cause the base station to select one or more of a subset of available beams for the wireless communication link based on the one or more measurements. For example, the base station could select a beam (or select one or more beams for measurement) for transmission from the base station to the UE. Additionally or alternatively, the base station could select a beam (or select one or more beams for measurement) for transmission from the UE to the base station. In some examples, the base station may inform the UE accordingly.

In some examples, the UE comprises a plurality of antennas, and configuring the wireless communication link based on the context of the UE and the detected movement comprises selecting at least one of the antennas for the wireless communication based on the context of the UE and/or the detected movement. Thus for example the predicted orientation of the UE in the target orientation may be used to select the appropriate antenna(s) for the wireless communication, to for example improve or enhance signal strength, throughput, reliability and/or any other property of the wireless communication as compared to using any other antenna(s) of the UE. Selecting at least one of the antennas may comprise selecting one or more of a plurality of antenna panels in some examples, where each antenna panel includes one or more individual antennas.

Configuring the wireless communication link based on the context of the UE and the detected movement in step 106 of the method 100 may in some examples comprise selecting for measurement a subset of available beams at the UE based on the context of the UE and/or the detected movement. Thus, as indicated above, only those beams considered to be useful or beneficial, or enhance one or more of the above-mentioned properties of the wireless communication, may be selected for measurement. The method 100 may then for example comprise performing one or more measurements on the subset of available beams, and may also comprise selecting one or more of the subset of available beams for the wireless communication based on the one or more measurements. Performing one or more measurements on the subset of available beams (i.e. a beam search) may be done in some examples in response to the detected movement. That is, the detected movement may prompt the UE to perform a beam search on the subset of available beams. Additionally or alternatively, in some examples, the method 100 may comprise reporting the one or more measurements to the base station to cause the base station to select one or more of the subset of available beams for the wireless communication based on the one or more measurements.

In some examples, the method 100 comprises predicting that the user will use the UE for the wireless communication based on the detected movement and the context of the UE. For example, this may predict whether the detected movement was purposed or non-purposed. In such examples, configuring the wireless communication link based on the context of the UE and the detected movement may comprise configuring the wireless communication link if the user is predicted to use the UE for the wireless communication. Additionally or alternatively, in some examples, the method 100 comprises predicting that the user will not use the UE for the wireless communication based on the detected movement and the context of the UE, e.g. predicting that the detected movement was unpurposed. In such examples, configuring the wireless communication link based on the context of the UE and the detected movement comprises maintaining a current configuration of the wireless communication link if the user is predicted to not use the UE for the wireless communication. The current configuration may be for example a default configuration. Examples of the current configuration may include an exhaustive search or hierarchical search of available beams at the UE, a default or current antenna or set of antennas, and/or any other suitable parameter.

FIG. 2 is a flow chart of an example of a method 200 of configuring a UE, and which may incorporate one or more of the methods described herein. The method 200 (or any other method described herein) may be implemented in a system consisting of (i) a first predictor which uses multiple types of information, including contextual information for the UE and sensor data that detects or may be used to detect movement of the UE (e.g. IMU sensor data), where the first predictor predicts if the current UE motion is purposed or non-purposed; and (ii) a second predictor which, for purposed UE motion, uses sensor data and other information such as contextual information and/or device type to predict the orientation of the UE in a target point (or plurality of target points). The system, which may be implemented in a UE, may use the predicted information to configure one or more parameters of wireless communication. In some examples, the configuration corresponds to determining a subset of beams for training. Additionally or alternatively, the configuration may correspond to the selection of an antenna in multi antenna transceivers, or selection of a subset of antennas for searching. In some examples of methods disclosed herein, in addition to the above examples of configuration of the wireless communication link or as an alternative, the predicted position/orientation may be reported to the base station associated with the UE. This may for example cause the base station to implement certain configuration(s) of the wireless communication link, such as for example selection of one or more beams for the wireless communication for searching by the UE or for the wireless communication.

Step 202 of the method 200 of FIG. 2 comprises, in response to trigger event(s) 204 and contextual information 206 of the UE, reading N initial samples of sensor data, such as IMU data. The contextual information in some examples may include, but is not limited to, one or more of background information available from device applications (e.g., whether there are any scheduled or incoming calls, received emails or other communications, etc.), a device type of the UE which may imply some orientation constraints (for example, a tablet is rarely held close to ears for talking), time of the day (for example, at night the device is expected to remain stationary on a table or other object when the user is sleeping), and/or any other device constraints. These examples may be applicable to any method as disclosed herein.

Next, step 208 comprises classifying the UE movement as being purposed or non-purposed. Step 210 determines whether the movement is purposed. If not, a default configuration is applied or used for the wireless communication link in step 212. If the movement is purposed, in step 214 the target orientation of the UE is predicted, based for example on the movement determined in step 202 and/or additional movement after step 202, and also optionally on constraints 216 such as the device type of the UE (e.g. a tablet or laptop computer is not expected to be held next to the user's ear during a phone call). Finally, in step 218, configuration of the UE (e.g. of the wireless communication link) is performed based on the predicted orientation.

In particular examples of step 208 for classifying the UE movement, a machine learning algorithm such as binary classification can be used to predict the type of UE movement. Alternatively, for example, a similarity matching algorithm can be used to calculate the similarity of the UE movement pattern to reference patterns of purposed UE movements of various types. Dynamic Time Warping (DTW) or other time series analysis techniques may be used along with the similarity matching algorithm in some examples to mitigate the impact of UE motion speed variation (e.g. between users and/or occurrences).

In particular examples of step 202 of reading N initial samples of sensor data (e.g. IMU sensor data), the parameter N, which may denote the number of sensor data readings, is predetermined. Alternatively, for example, the parameter N can be learned in a supervised machine learning system. N may be fixed, though in other examples, N may be dynamic and can change with respect to the UE state, for example with respect to the battery state of the UE to e.g. to save battery by reading and/or processing fewer readings. In some examples, N samples of sensor data may be read consecutively, starting from a start point (e.g. trigger event 204). In other examples, the N samples of sensor data are read uniformly within a given time interval after the start point (e.g., read N samples within time interval [t0, t0+Δ], where t0 is the time corresponding to the start point). In other examples, N sensor data readings may be read arbitrarily from any time interval incident and enclosed by start point and target point.

In particular examples of step 214 of predicting the target UE orientation, the UE orientation may be predicted for a single target point. In other examples, the UE orientation may be predicted for a target point and points in the neighborhood of a target point. In other examples, the orientation of UE may be predicted for one or more arbitrary points along the trajectory from a start point (e.g. at the trigger event 204, or after determining in step 210 that the movement is purposed) to the target point, including the target point (target orientation). In some examples, the UE orientation may be predicted using machine learning techniques such as deep learning and reinforcement learning. In other examples, simple regression techniques can be used to predict the UE orientation.

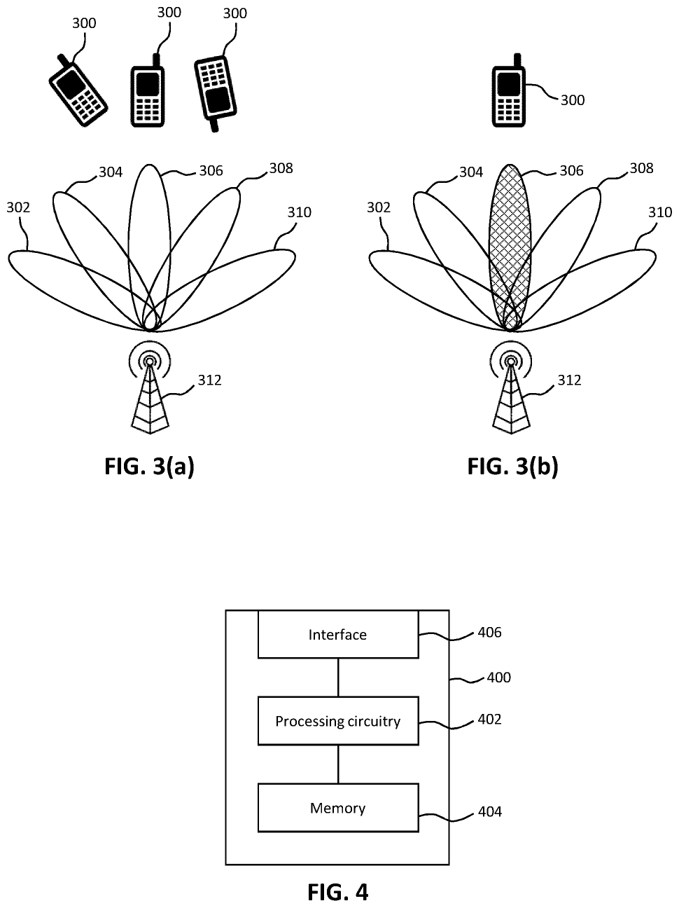

FIGS. 3(a) and 3(b) show examples of selection of a subset of available beams for measurement or use according to some examples such as those described above. In FIG. 3(a), a UE 300 may be in one or any number of orientations, due to random or unpurposed movement. Thus, for example, no particular orientation of the UE 300 may be predicted. In FIG. 3(a), three random orientations are shown, though the UE 300 may be in any suitable or random orientation.

Also shown are five beams 302, 304, 306, 308 and 310 provided by a base station 312. In the example shown in FIG. 3(a), the orientation of the UE 300 is not predicted, and therefore it may be that any one of the beams 302-310 is the best beam to use for the communication link between the base station 312 and the UE. As such, the UE may search and perform measurements of all of the beams, e.g. in a default, exhaustive or hierarchical search, to find the best beam.

In the example shown in FIG. 3(b), the orientation of the UE 300 is predicted to be the one shown. In this orientation, one or more of the beams 302-310 (i.e. a subset) may be selected for a search as they may be deemed the best beams the shaded beam 306 is determined to be the best beam for the communication link. Therefore, a search may be restricted to the selected beams. In this example, only one beam, the shaded beam 306, is selected.

FIG. 4 is a schematic of an example of apparatus 400 for configuring a UE. The apparatus 400 comprises processing circuitry 402 (e.g. one or more processors) and a memory 404 in communication with the processing circuitry 402. The memory 404 contains instructions executable by the processing circuitry 402. The apparatus 400 also comprises an interface 406 in communication with the processing circuitry 402. Although the interface 406, processing circuitry 402 and memory 404 are shown connected in series, these may alternatively be interconnected in any other way, for example via a bus.

In one embodiment, the memory 404 contains instructions executable by the processing circuitry 402 such that the apparatus 400 is operable to detect a movement of the UE, determine a context of the UE in response to the detected movement, and configure a wireless communication link between the UE and a base station based on the context of the UE and the detected movement. In some examples, the apparatus 400 is operable to carry out the method 100 described above with reference to FIG. 1.

It should be noted that the above-mentioned examples illustrate rather than limit the invention, and that those skilled in the art will be able to design many alternative examples without departing from the scope of the appended statements. The word “comprising” does not exclude the presence of elements or steps other than those listed in a claim, “a” or “an” does not exclude a plurality, and a single processor or other unit may fulfil the functions of several units recited in the statements below. Where the terms, “first”, “second” etc. are used they are to be understood merely as labels for the convenient identification of a particular feature. In particular, they are not to be interpreted as describing the first or the second feature of a plurality of such features (i.e. the first or second of such features to occur in time or space) unless explicitly stated otherwise. Steps in the methods disclosed herein may be carried out in any order unless expressly otherwise stated. Any reference signs in the statements shall not be construed so as to limit their scope.

1. A method of configuring a User Equipment, UE, the method comprising:
detecting a movement of the UE;
determining a context of the UE in response to the detected movement;
predicting that the user will use the UE for communication based on the detected movement and the context of the UE; and
configuring a wireless communication link between the UE and a base station based on the context of the UE and the detected movement, configuring the wireless communication link based on the context of the UE and the detected movement comprises configuring the wireless communication link if the user is predicted to use the UE for communication.

2. (canceled)

3. The method of claim 1, comprising:
predicting that the user will not use the UE for communication based on the detected movement and the context of the UE; and
wherein configuring the wireless communication link based on the context of the UE and the detected movement comprises maintaining a current configuration of the wireless communication link if the user is predicted to not use the UE for communication.

4. The method of claim 3, wherein the current configuration of the wireless communication link comprises an exhaustive search or hierarchical search of available beams at the UE.

5. The method of claim 1, wherein configuring the wireless communication link between the UE and a base station based on the context of the UE and the detected movement comprises:
predicting an orientation or range of orientations of the UE based on one or both of the context of the UE and the detected movement; and
configuring the wireless communication link between the UE and a base station based on the predicted orientation or range of orientations of the UE.

6. The method of claim 5, comprising predicting the orientation or range of orientations of the UE based additionally on additional movement of the UE after the detecting.

7. The method of claim 6, comprising predicting the orientation or range of orientations of the UE based additionally on the additional movement using a pattern matching, linear regression or machine learning algorithm.

8. The method of claim 5, comprising predicting the orientation or range of orientations of the UE based on the detected movement using a pattern matching, linear regression or machine learning algorithm.

9. The method of claim 5, comprising reporting the orientation or range of orientations to the base station to cause the base station to select one or more of a subset of available beams for the wireless communication link based on the one or more measurements.

10. The method of claim 1, wherein detecting the movement of the UE comprises detecting the movement based on sensor data from at least one of a motion sensor, accelerometer, inertial motion unit, gyroscope, compass and camera.

11. The method of claim 1, wherein the context of the UE comprises one or more of a current time, a device type of the UE, or whether the UE is receiving or has one or both of:
received one or more of an incoming call, notification, text message, email or other communication; or
whether a user of the UE has one or more of any calls, meetings, appointments or communications scheduled for a current time.

12. The method of claim 1, wherein the UE comprises a plurality of antennas, and configuring the wireless communication link based on the context of the UE and the detected movement comprises selecting at least one of the antennas for the wireless communication based on one or both of the context of the UE or the detected movement.

13. The method of claim 1, wherein configuring the wireless communication link based on the context of the UE and the detected movement comprises selecting for measurement a subset of available beams at the UE based on one or both of the context of the UE or the detected movement.

14. The method of claim 13, comprising performing one or more measurements on the subset of available beams.

15. The method of claim 14, comprising performing the one or more measurements on the subset of available beams in response to the detected movement.

16. The method of claim 14, comprising selecting one or more of the subset of available beams for the wireless communication based on the one or more measurements.

17. The method of claim 14, comprising reporting the one or more measurements to the base station to cause the base station to select one or more of the subset of available beams for the wireless communication link based on the one or more measurements.

18. A computer storage medium storing a computer program comprising instructions which, when executed on at least one processor, cause the at least one processor to:
detect a movement of a UE;
determine a context of the UE in response to the detected movement;
predict that the user will use the UE for communication based on the detected movement and the context of the UE; and
configure a wireless communication link between the UE and a base station based on the context of the UE and the detected movement, configuring the wireless communication link based on the context of the UE and the detected movement comprises configuring the wireless communication link if the user is predicted to use the UE for communication.

19. (canceled)

20. (canceled)

21. An apparatus for configuring a User Equipment, UE, the apparatus comprising a processor and a memory, the memory containing instructions executable by the processor to configure the apparatus to:
detect a movement of the UE;
determine a context of the UE in response to the detected movement;
predict that the user will use the UE for communication based on the detected movement and the context of the UE; and
configure a wireless communication link between the UE and a base station based on the context of the UE and the detected movement, configuring the wireless communication link based on the context of the UE and the detected movement comprises configuring the wireless communication link if the user is predicted to use the UE for communication.

22. The apparatus of claim 21, wherein the memory contains instructions executable by the processor to configure the apparatus to predict that the user will not use the UE for communication based on the detected movement and the context of the UE; and
wherein configuring the wireless communication link based on the context of the UE and the detected movement comprises maintaining a current configuration of the wireless communication link if the user is predicted to not use the UE for communication.

23. (canceled)

24. The method of claim 3, wherein configuring the wireless communication link between the UE and a base station based on the context of the UE and the detected movement comprises:
predicting an orientation or range of orientations of the UE based on one or both of the context of the UE and the detected movement; and
configuring the wireless communication link between the UE and a base station based on the predicted orientation or range of orientations of the UE.
